(19) United States
(12) Patent Application Publication
(10) Pub. No.: US 2004/0158179 A1
(43) Pub. Date: Aug. 12, 2004

(54) Fat-removal massager

(76) Inventor: Jung-Tsung Chen, Taichung (TW)

Correspondence Address: Kuo-Hsiung Chiu, 13F., No. 23, Jiun-Ho Street, Peitun District, Taichung, 406, TW

(21) Appl. No.: 10/361,187

(22) Filed: Feb. 10, 2003

(51) Int. Cl. A61H 7/00

(52) U.S. Cl. 601/87; 601/112; 601/133; 601/134

(57) ABSTRACT

The present invention relates to a fat-removal massager utilizing a speed-adjustable motor in combination with two corresponding gear sets for driving a plurality of eccentrically rotatable massaging balls. Moreover, every two neighboring massaging balls in rotation create a rapid squeezing effect upon muscles for achieving the expected fat-removing and massaging goal.

### BACKGROUND OF THE INVENTION

1. Field of the Invention

The present invention relates to a new and improved fat-removal massager, and more particularly, to an apparatus which can be used everywhere and held by a single hand to achieve the massaging and fat-removing effect.

2. Description of the Prior Art

The commercially available massagers work in the vibrating or in-place striking way. The vibrating massager makes use of the rapid vibration to achieve the relaxing and vibrating effect upon the local muscles. The in-place striking massager exerts a certain pressure on the local point (acupuncture point) of muscles to achieve the effect of relaxing muscles and nerves.

The above-mentioned massagers can create relaxing effect on the local muscles. However, they can't produce squeezing and fat-removing effect upon the muscles containing much fat. Thus, it's necessary to improve them.

### SUMMARY OF THE INVENTION

It is a primary object of the present invention to eliminate the above-mentioned drawbacks and to provide a fat-removal massager which utilizes a speed-adjustable motor in combination with two corresponding gear sets for driving a plurality of eccentrically rotatable massaging balls. Moreover, every two neighboring massaging balls in rotation create a rapid squeezing effect upon muscles for achieving the expected fat-removing and massaging goal.

### BRIEF DESCRIPTION OF THE DRAWINGS

The accomplishment of this and other objects of the invention will become apparent from the following description and its accompanying drawings of which:

FIG. 1 is a local section of a preferred embodiment of the present invention;

FIG. 2 is a sectional view taken along the line A-A of the preferred embodiment in FIG. 1; and

FIG. 3 is a bottom view of the preferred embodiment in FIG. 1.

### DETAILED DESCRIPTION OF THE PREFERRED EMBODIMENT

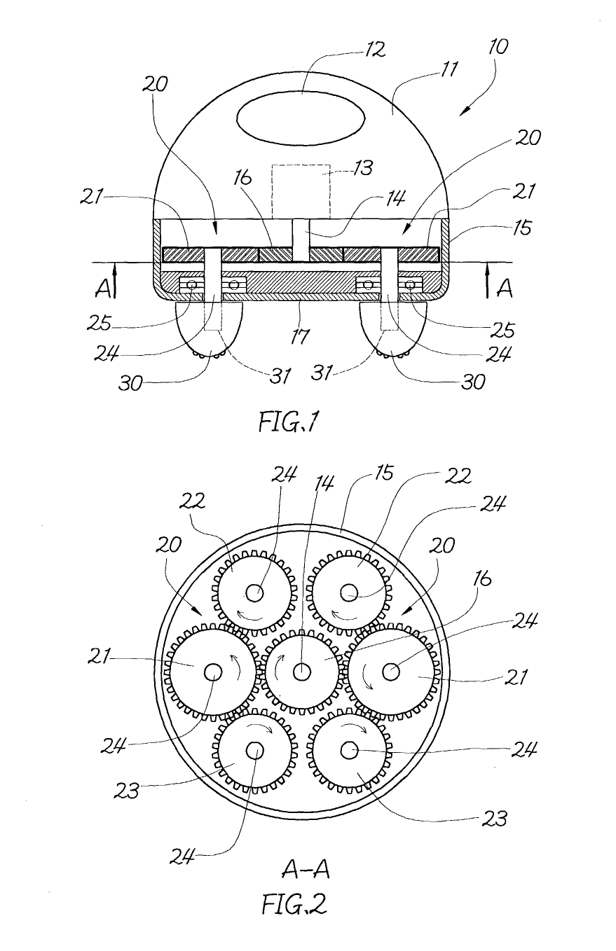

First of all, referring to FIGS. 1 and 2, a preferred embodiment of the present invention is shown. The present invention includes:

a main body 10 having a handle portion 12 at the upper section 11 thereof and a speed-adjustable motor 13 within the main body, the speed-adjustable motor 13 having a shaft 14 extending downwards into the inside of the lower section 15 of the main body 10 for bringing a primary transmission gear 16 in motion;

two pairs of gear sets 20 positioned within the lower section 15 of the main body 10 and arranged around the primary transmission gear 16 to form a circle, each of the gear sets 20 having a secondary transmission gear 21 and two driven gears 22, 23, each of the gears 21, 22, 23 being coupled with a massaging ball 30 by means of an axle 24 and a bearing 25, each of the massaging balls 30 being protruding outside a bottom cover 17 of the lower section 15 of the main body 10 after assembly, each of the massaging balls 30 being coupled with the axle 24 through an eccentric hole 31.

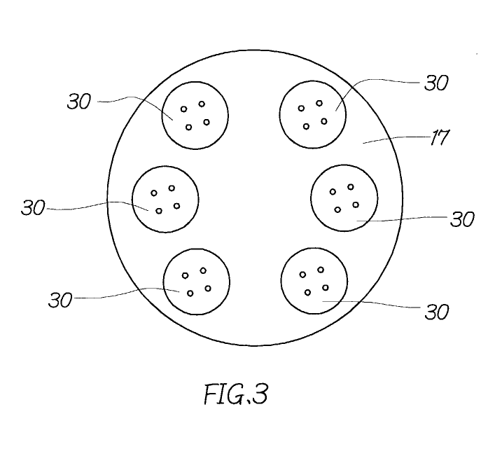

Based upon the assembly of the aforementioned components, when the motor 13 is actuated to bring the primary transmission gear 16 in rotation, the secondary transmission gears 21 at both sides of the primary transmission gear 16 are also rotated. Therefore, both driven gears 22, 23 are rotated with the secondary transmission gear 21. As illustrated in FIGS. 2 and 3, every two neighbored massaging balls 30 create an inwardly pressing movement due to the opposite rotational state. Thus, when the present invention is placed upon the waist, the abdomen, etc. every two neighbored massaging balls 30 produce a proper pressing effect on the local muscle, thereby achieving the fat-removing effect.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A fat-removal massager utilizing a speed-adjustable motor in combination with two corresponding gear sets for driving a plurality of eccentrically rotatable massaging balls wherein every two neighbored massaging balls in rotation create a rapid squeezing effect upon muscles.

2. The fat-removal massager comprising:
a) a main body having a handle portion at the upper section thereof and a speed-adjustable motor within the main body, the speed-adjustable motor having a shaft extending downwards into the inside of the lower section of the main body for bringing a primary transmission gear in motion; and
b) two pairs of gear sets positioned within the lower section of the main body and arranged around the primary transmission gear to form a circle, each of the gear sets having a secondary transmission gear and two driven gears, each of the gears being coupled with a massaging ball by means of an axle and a bearing, each of the massaging balls being protruding outside a bottom cover of the lower section of the main body after assembly, each of the massaging balls being coupled with the axle through an eccentric hole.
